(19) United States
(12) Patent Application Publication
(10) Pub. No.: US 2010/0050704 A1
(43) Pub. Date: Mar. 4, 2010

(54) ELECTROLYTIC MIST GENERATOR AND WASHING MACHINE USING THE SAME

(75) Inventors: Hiroyuki Fujii, Osaka (JP); Hironao Numoto, Osaka (JP); Tadashi Asami, Osaka (JP)

Correspondence Address: Brinks Hofer Gilson & Lione/Panasonic, P.O. Box 10395, Chicago, IL, 60610, US

(73) Assignee: PANASONIC CORPORATION, KADOMA-SHI (JP)

(21) Appl. No.: 12/513,992

(22) PCT Filed: Nov. 8, 2007
(86) PCT No.: PCT/JP2007/071681

§ 371 Date: May 7, 2009

(30) Foreign Application Priority Data
Nov. 20, 2006 (JP) 2006-312605

(51) Int. Cl. B08B 3/12; B05B 1/08

(52) U.S. Cl. 68/5 C; 239/102.2

(57) ABSTRACT

An electrolytic mist generating device includes electrode parts arranged inside an electrolytic cell, a piezoelectric element that generates mist of electrolytic water, a water supply device that supplies water into the electrolytic cell, and a blowing fan that discharges the mist generated in the electrolytic cell from a mist outlet, so that both production of the electrolytic water and mist generation of the electrolytic water are performed in the electrolytic cell.

### TECHNICAL FIELD

The present invention relates to an electrolytic mist generating device capable of disinfecting and antibacterial actions by mist generation, and a washing machine using the same.

### BACKGROUND ART

In recent years, technology for subjecting laundry to antibacterial treatment during washing has been proposed. For example, Patent Literature 1 discloses an electric washing machine with an ion generator that generates a metal ion having bacteriocidal capacity. Patent Literature 2 discloses a washing machine with an Ag ion adding unit that adds an Ag ion to cleaning water. Patent Document 3 discloses a washing machine that water with an Ag ion eluted is sprayed onto clothing in a shower-like manner. Patent Literature 4 discloses a drier that squirts, on laundry, mist of water with an Ag ion eluted.

Typically, the elution of a metal ion is performed by electrolysis. Applying a voltage between electrodes for electrolysis allows the metal ion to be eluted from the anodic electrode in accordance with Faraday's law.

However, in Patent Literatures 1 and 2, the water with the metal ion eluted is used in rinsing, and thus, the metal ion not attached to the clothing is discarded as drainage. Most of the metal ion thus goes to waste. Moreover, in Patent Literatures 3 and 4, the elution of the Ag ion is performed by a flow method using a flow path from water service, and thus, only low-concentrated Ag ion electrolytic water is created. Therefore, a great amount of electrolytic water is needed for obtaining the Ag ion that brings about the antibacterial effect to the washed clothing. In this case, since a piezoelectric element cannot generate so much mist per unit time, processing time becomes very long.

[Patent Literature 1] Unexamined Japanese Utility Model Publication No. H05-74487

[Patent Literature 2] Unexamined Japanese Patent Publication No. 2001-276484

[Patent Literature 3] Unexamined Japanese Patent Publication No. 2005-87712

[Patent Literature 4] Unexamined Japanese Patent Publication No. 2006-141579

### DISCLOSURE OF THE INVENTION

One aspect of the present invention is an electrolytic mist generating device including an electrolytic cell, electrode parts where a pair of positive pole and negative pole are arranged in parallel and opposed to one another in the electrolytic cell, a piezoelectric element that generates mist of electrolytic water generated inside the electrolytic cell, a water supply device that supplies water into the electrolytic cell, and a discharging device that discharges the mist from the electrolytic cell, wherein production of the electrolytic water and mist generation are performed in the electrolytic cell. With this configuration, since the electrolysis in the electrode parts is performed by a batch method, desired high-concentration metal ion water can be stably obtained in accordance with an electrolytic current value and an electrolysis time. By giving both the mist generating function and the water circulating function to the piezoelectric element, production of the electrolytic water and mist generation of the generated electrolytic water can be performed in the same housing, so that compactification of the electrolytic mist generating device is enabled. Efficiently circulating aqueous solution during an electrolysis step can prevent harmful effects such as nonuniformity of the solution accompanying the batch method.

Preferably, a configuration is made such that a rectifier is provided above the electrode parts, that the piezoelectric element generates a water column toward the rectifier, and that the discharging device supplies wind to the water column from sides thereof. With this configuration, the water column and crushing water generated from the piezoelectric element are blocked off by the rectifier to be returned downward, and supplied wind flows in an inside direction from both sides of the rectifier to crash against the water column generated from the piezoelectric element from a substantially side surface direction, which can efficiently generate the mist by water detachment from the water column and the crushing water. Moreover, such a layout enables compactification in a height direction of the mist generating device.

Preferably, the rectifier is provided in a concave shape with a side of the piezoelectric element opened to receive at least part of the water column. This allows the supplied wind to smoothly flow in the inside direction from both the sides of the rectifier, which can efficiently generate the mist by water detachment from the water column and the crushing water.

Preferably, the water column generated by the piezoelectric element is formed by a water flow passing between the electrode parts. This allows the water circulation in the electrolysis step to be smoothly performed, and can prevent the harmful effects such as nonuniformity of the solution accompanying the batch method.

Preferably, the electrolytic cell has a recessed part having a predetermined depth in a bottom portion thereof, and the piezoelectric element is arranged inside the recessed part so as to be inclined. This can reduce stored water on a surface required for protecting the piezoelectric element as much as possible, and can reduce an aqueous solution with a metal ion eluted that is involuntarily wasted as drainage after a mist processing step.

Preferably, the electrolytic cell is provided with a recessed part in a bottom portion thereof to dispose the piezoelectric element therein, and in the recessed part, a water supply and drain port communicating with the electrolytic cell is provided. With this configuration, the water supply and drain port is provided in direct connection to the recessed part where the piezoelectric element is disposed, which can reduce deposits to the inside of the electrolytic mist generating cell as much as possible. Moreover, passing the supply water and the drainage on the piezoelectric element surface can restrain extraneous substance from attaching to the piezoelectric element surface.

Preferably, the electrolytic cell is configured so as to restrain light from entering an inside thereof. This can restrain deposits from being caused due to oxidation of the electrolytic water by the light, resulting in a large reduction in deposit.

Preferably, a material of the rectifier is any one of stainless steel, ceramics, and glass. With this configuration, even after the water column generated from the piezoelectric element crashes against a control plate, possessed energy is not largely attenuated. Accordingly, by crashing the water column against the control plate, largely compactification in the height direction of the electrolytic mist generating device can be achieved without largely reducing the volume of generated mist.

Preferably, the electrolytic cell has floats that guide wind to be supplied to the water column in accordance with a water level surface. This can favorably return the wind passing the rectifier in a direction toward the water column generated from the piezoelectric element, and thus, the mist can efficiently be detached from the water column.

Another aspect of the present invention is a washing machine including the electrolytic mist generating device, a washing tub that contains laundry, an outer tub in which the washing tub is internally mounted rotatably, and a water supply device that supplies washing water to the outer tub, wherein mist of electrolytic water generated by the electrolytic mist generating device is supplied to the washing tub. This can bring about disinfecting and antibacterial actions to the clothing, and a mildewproofing action to the washing tub as well. By setting an attachment position of the electrolytic mist generating device to a front-surface-side upper portion of horizontal or oblique type washing tub, a user can observe contact of the generated mist having an average particle diameter of 10 □m with the washed clothing inside the washing tub, so that the user can visually check the clothing processing step with the mist.

Preferably, an inner surface of an introduction part from the electrolytic mist generating device to the washing tub of the washing machine is subjected to water repellent treatment. This allows the generated mist to reach the washed clothing while restraining, as much as possible, loss of the mist due to attachment to a wall surface until it is introduced to the washing tub.

### BRIEF DESCRIPTION OF THE DRAWINGS

FIG. 1 is a configuration view of an electrolytic mist generating device of Embodiment 1 of the present invention.

FIG. 2 is a cross-sectional view of FIG. 1.

FIG. 3 is a top view showing an arrangement of electrode parts and a piezoelectric element inside an electrolytic cell of the electrolytic mist generating device of Embodiment 1 of the present invention.

FIG. 4 is a cross-sectional view of a washing and drying machine mounting the same electrolytic mist generating device.

FIG. 5 is a back view of FIG. 4.

FIG. 6 is a system flowchart of the electrolytic mist generating device of Embodiment 1 of the present invention.

FIG. 7 is a configuration view of an electrolytic mist generating device of Embodiment 2 of the present invention.

FIG. 8 is a configuration view of an electrolytic mist generating device of Embodiment 3 of the present invention.

FIG. 9 is a side view showing a relation between floats and guiding members in FIG. 8.

FIG. 10 is a top view showing the relation between the floats and the guiding members in FIG. 8.

### DESCRIPTION OF REFERENCE MARKS

1 electrolytic cell
2 electrode part
4 piezoelectric element
5 recessed part
6 rectifier
7 blowing fan
8 mist outlet
9 water supply and drain port
10 body
12 cylindrical outer tub
13 clothing
14 cylindrical inner tub
15 drive motor
40 electrolytic mist generating device
41 mist introducing path
43 vertically guiding member
44 float
50 water supply device
70 discharging device

### PREFERRED EMBODIMENTS FOR CARRYING OUT OF THE INVENTION

Hereinafter, embodiments of the present invention are described with reference to the drawings. These embodiments, however, do not limit the present invention.

### Embodiment 1

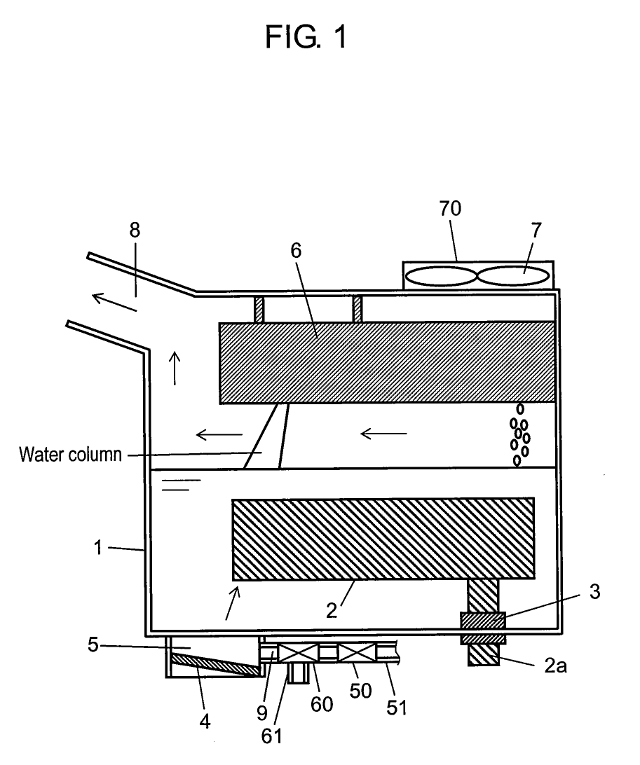

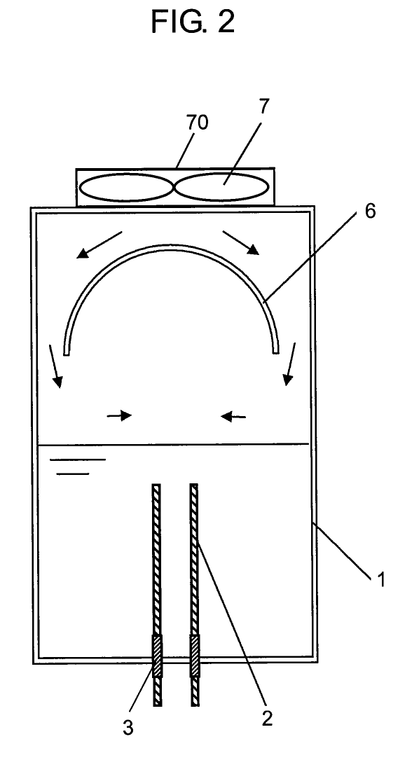

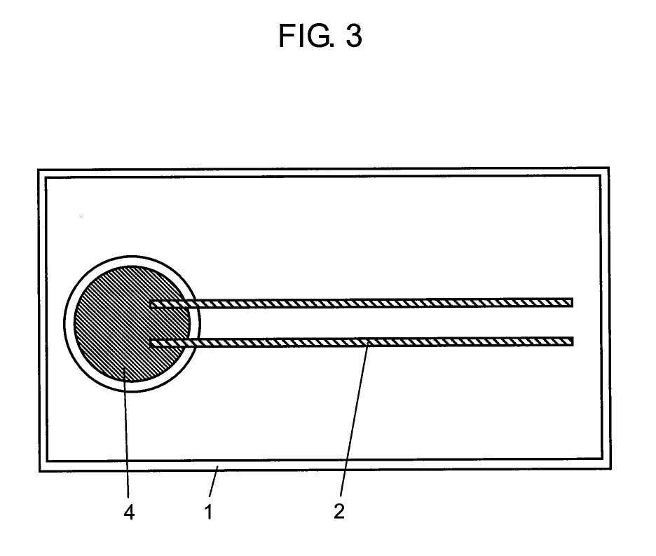

FIG. 1 is a schematic configuration view of an electrolytic mist generating device according to Embodiment 1 of the present invention, FIG. 2 is a cross-sectional view of FIG. 1, and FIG. 3 is a top view of electrode parts and a piezoelectric element of the electrolytic mist generating device of Embodiment 1 of the present invention.

Two sheets of electrode parts 2 are arranged in parallel with respect to a bottom surface of electrolytic cell 1. Electrode parts 2 are specifically Ag plates of 2 cm×5 cm having a thickness of 1.2 mm, and spaced from each other at a distance of 8 mm. Terminal part 2a for applying a voltage through rubber packing 3 from each of electrode parts 2 is drawn outside electrolytic cell 1. Each of electrode parts 2 is fixed to the bottom surface of electrolytic cell 1 by rubber packing 3.

Piezoelectric element 4 is arranged adjacent to a position where a generated water column is formed by a water flow passing between two sheets of electrode parts 2. In a bottom portion, there is provided recessed part 5 having a predetermined depth of 15 mm from the bottom surface of electrolytic cell 1, where piezoelectric element 4 is disposed so as to keep an inclination of about 10 degrees. As a result, the water column generated from piezoelectric element 4 is formed with an angle in an oblique direction and is formed by the water flow passing between electrode parts 2 spaced from each other at a distance of 8 mm, so that a circulating water path from piezoelectric element 4 toward a water column falling direction can be formed. Specifically, piezoelectric element 4 of Φ20 mm and 1.6 MHz for rated AC 48V is used.

Moreover, above electrode parts 2, rectifier 6 having a substantially semi-cylindrical shape is disposed in a portion at a certain distance from a top surface position of electrolytic cell 1 so as to be fixed to a top surface portion. Specifically, rectifier 6 has a semi-cylindrical shape of Φ35 mm×60 mm, and is made of glass having thickness of 1 mm, and further has a concave shape with a side of piezoelectric element 4 opened to receive part of the water column. Thus, rectifier 6 is laid out so that during the mist supply, the water column generated from piezoelectric element 4 crashes against rectifier 6 having the substantially semi-cylindrical shape while performing water crushing, and that the water then falls between two sheets of electrode parts 2 to be returned.

On the top surface of electrolytic cell 1 about 10 mm above rectifier 6 having the substantially semi-cylindrical shape, there is disposed blowing fan 7 as discharging device 70 that discharges mist generated inside electrolytic cell 1. Blowing fan 7 is made of an axial flow fan having a diameter of 30 mm. A configuration is made such that wind from blowing fan 7 is blocked off by rectifier 6 having the substantially semi-cylindrical shape, passes through clearances of about 5 mm between an inner wall surface of electrolytic cell 1 and rectifier 6, and flows in an inside direction, so that the wind is supplied to the water column generated from the piezoelectric element 4 from a side surface direction. In a side-surface upper portion of electrolytic cell 1, there is disposed mist outlet 8. A configuration is employed in which as a housing of electrolytic cell 1, a material obtained by adding 2 wt % of titanic oxide to propylene resin is used to prevent light from intruding inside. This can restrain the light from entering.

Moreover, in recessed part 5 of electrolytic cell 1 where piezoelectric element 4 is disposed, water supply and drain port 9 is provided. Switching valve 60 connects water supply and drain port 9 to water supply device 50 during water supply and to drain pipe 61 during drainage. Water service pipe 51 is connected to water supply device 50. A water level sensor (not shown) is provided in electrolytic cell 1 to perform water-supply upper-limit level management to electrolytic cell 1 and lower-limit level management when the mist is generated.

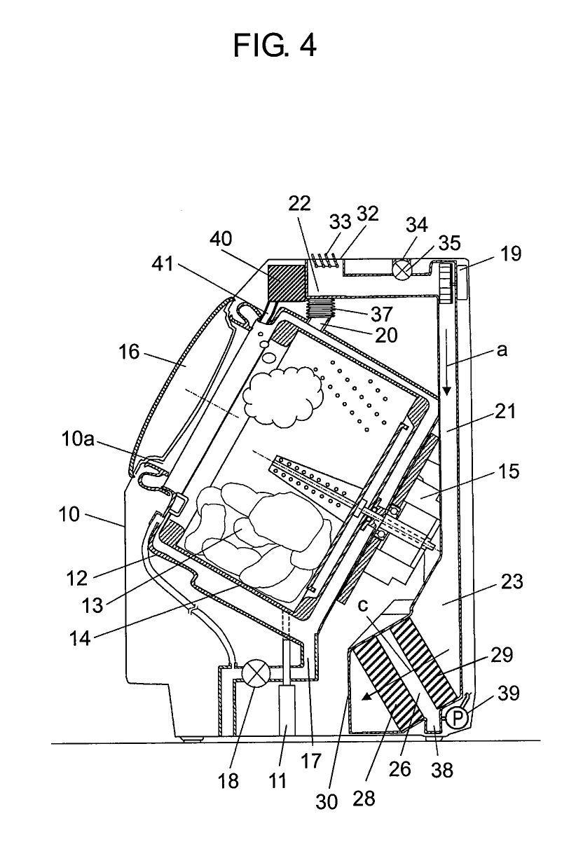

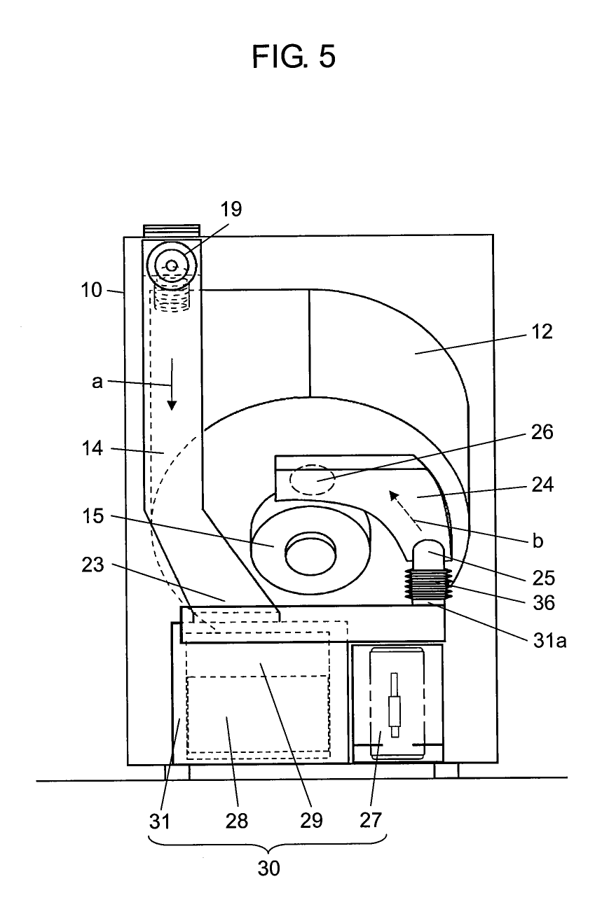

FIG. 4 is a cross-sectional view of a washing and drying machine with the electrolytic mist generating device of Embodiment 1 of the present invention installed, and FIG. 5 is a back view of FIG. 4.

Cylindrical outer tub 12 supported elastically by a plurality of suspensions 11 is provided inside body 10, and vibrations during washing and spin drying are absorbed by suspensions 11. Inside outer tub 12, cylindrical inner tub 14 to contain clothing 13 is rotatably provided, and is rotatively driven by drive motor 15 as a drive device. Outer tub 12 serves as a washing chamber of clothing 13 in a washing step and serves as a drying chamber of clothing 13 in a drying step.

Opening part 10a for taking clothing 13 in and out, and door 16 for opening and closing the same are provided in a front surface of body 10. Door 16 is made of transparent glass so that the clothing inside the washing tub can be observed. Outer tub 12 and inner tub 14 also have similar opening parts on the front surface side thereof, and this opening part of outer tub 12 is watertightly joined to opening part 10a of body 10 by a bellows. In a bottom portion of outer tub 12, drain port 17 for discharging washing water is provided, and is joined to drain valve 18 that opens and closes a drain path. Drain valve 18 is closed during washing so that a predetermined volume of washing water can be stored in outer tub 12. Blower 19 as a blowing device is provided in an upper portion of body 10.

Blower 19 suctions drying air, which has passed through inner tub 14 and outer tub 12, from outer tub outlet 20 provided above outer tub 12, and blows an inside of upstream circulating air path 21 provided in a back surface of outer tub 12 to derive the air from upstream circulating air-path inlet 22 to upstream circulating air-path outlet 23 as indicated by arrow a. Moreover, downstream circulating air path 24 is provided in an outer surface of outer tub 12, and the drying air coming in through downstream circulating air-path inlet 25 is blown in a direction of arrow b to be supplied into outer tub 12 and inner tub 14 through blowing port 26.

In a back-surface lower portion of outer tub 12 is arranged heat pump device 30 in which compressor 27, radiator 28 that radiates heat of a compressed refrigerant, a pressure reducing device (not shown) for reducing a pressure of the high-pressure refrigerant, and heat absorber 29 in which the low-pressure refrigerant resulting from the reduction of pressure removes heat from a vicinity are joined to one another by pipe line so as to circulate the refrigerant through them, and an empty space inside body 10 is effectively utilized to house heat pump device 30. Heat-exchanging air path 31 serves to cause the air blown by blower 19 to flow from heat absorber 29 to heat radiator 28 in a direction of arrow c, and compressor 27 is contained alongside of heat absorber 29 and heat radiator 28 in a lateral direction of body 10 inside heat-exchanging air path 31. An inlet side of heat-exchanging air path 31 is communicated with upstream circulating air-path outlet 23, and an outlet side thereof is communicated with downstream circulating air-path inlet 25.

In upstream circulating air path 21 from outer tub 12 to heat absorber 29, exhaust port 32 for exhausting the air flowing here outside body 10 is provided in an upper surface of body 10. Freely opened and closed louver 33 is provided in exhaust port 32 so as to enable selection as to whether or not to perform the exhaust from exhaust port 32 and adjustment of an exhaust direction.

Moreover, intake port 34 for taking in external air is provided downstream of exhaust port 32 in upstream circulating air path 21. Intake port 34 is located between exhaust port 32 and blower 19, and an opening and closing device of intake port 34 is made of intake valve 35 consisting of an opening and closing valve such as an electromagnetic valve so as to enable selection as to whether or not to perform the intake.

Downstream circulating air-path inlet 25 and heat-exchanging air-path outlet 31a are communicated through air supply hose 36 made of a flexible material, which is capable of extension and contraction in a bellows-like manner, and outer tub outlet 20 and upstream circulating air-path inlet 22 are communicated through exhaust hose 37 made of a flexible material, which is capable of extension and contraction in a bellows-like manner, which prevents the vibrations of outer tub 12 from being transmitted to heat pump device 30. Moreover, in a lower portion of heat-exchanging air path 31, drain water vessel 38 for collecting dehumidified water from heat absorber 29 is provided, and the water collected in drain water vessel 38 is discharged outside the machine from drain pump 39.

In heat pump device 30, compressor 27, radiator 28 that radiates heat of the compressed refrigerant, the pressure reducing device for reducing the pressure of the high-pressure refrigerant and made of a throttle valve, a capillary and the like, and heat absorber 29 in which the low-pressure refrigerant resulting from the reduction of pressure removes heat from the vicinity are joined to one another by pipe line so as to circulate the refrigerant through them, so that a heat pump cycle is realized.

Electrolytic mist generating device 40 is arranged in a front upper portion of body 10. Mist introducing path 41 joins electrolytic mist generating device 40 and outer tub 12 to lead generated mist to inner tub 14, thereby enabling mist processing for clothing 13. Mist introducing path 41 is subjected to water repellent treatment in order to restrain mist attachment to a path wall surface as much as possible

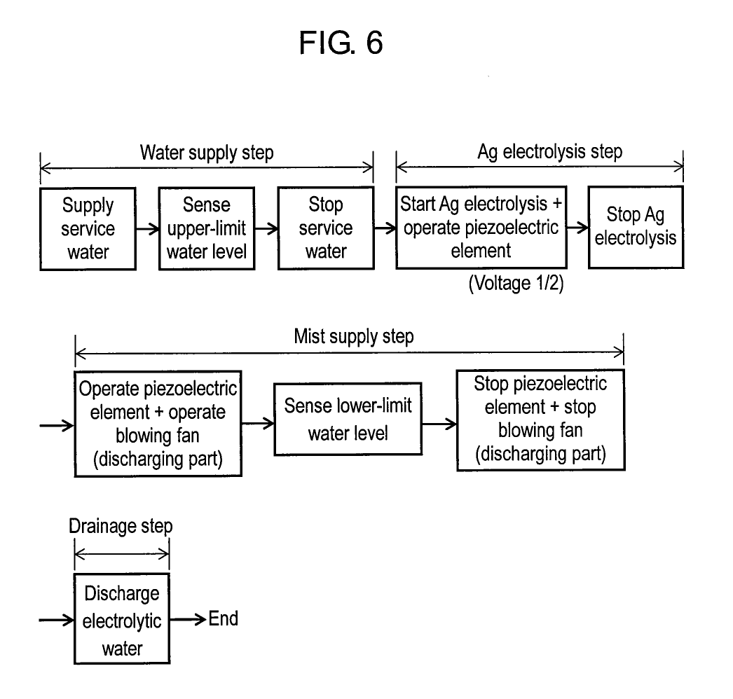

Next, operation of the electrolytic mist generating device is described. FIG. 6 is a system flowchart showing the operation of the electrolytic mist generating device of Embodiment 1 of the present invention.

First, a water supply step of supplying service water into electrolytic cell 1 up to a predetermined water level is performed. Water supply device 50 supplies water into electrolytic cell 1 through switching valve 60 and water supply and drain port 9 and stops the water supply when the predetermined water level is sensed by the water level sensor. For example, service water of about 100 ml having a hardness of about 40 and an electric conductivity of 150 μS/cm is supplied, so that the water level in electrolytic cell 1 becomes 30 mm from the bottom surface.

Thereafter, as an electrolysis step, AC 24 V is applied to piezoelectric element 4 so as to enable the water inside electrolytic cell 1 to circulate therethrough. Almost concurrently, a voltage is applied utilizing a constant current circuit so as to pass DC 30 mA through electrode parts 2. The water column generated from piezoelectric element 4 is formed by a water flow passing between electrode parts 2, and returning water after forming the water column in an oblique upper direction also falls between electrode parts 2, thereby increasing an effect of putting the electrolytic water into a uniform state. Electrolysis is performed for a total of 200 seconds while a polarity of the electrodes to which the voltage is applied is inverted every about 20 seconds. At this time, about 15 V is applied as a DC voltage. As a result, an aqueous solution of about 50 ppm containing an Ag ion and AgCl, which is cloudy to some extent, is obtained.

Thereafter, as a mist supply step, AC 48 V is applied to piezoelectric element 4 to produce a state capable of generating the mist. At the same time, blowing fan 7 and drive motor 15 are also activated. Although the water column generated from piezoelectric element 4 crashes against rectifier 6 while performing water crushing, it does not lose retained energy after crashing against rectifier 6, and then, water detachment is created by blowing fan 7. As a result, the mist generated by piezoelectric element 4 is discharged from mist outlet 8 by blowing fan 7 and arrives at washed clothing 13 in inner tub 14 through mist introducing path 41.

Wind of about 50 L/min. is introduced into inner tub 14 by blowing fan 7. At this time, clothing 13 weighs about 4 kg based on dry weight. The electrolytic mist can be generated at a level of about 10 ml/min by piezoelectric element 4, and variation in volume of generated mist is caused to some extent depending on the water level. The mist supply step continues until the water level sensor senses the predetermined water level, and when it is sensed, piezoelectric element 4 and blowing fan 7 stop. For example, by sensing timing when the water level reaches recessed part 5 from the bottom surface of electrolytic cell 1, a volume of the electrolytic ion water to be subsequently discharged can be reduced.

The mist will be attached to entire clothing 13 by drive motor 15 for about 10 minutes while clothing 13 is tumbled inside inner tub 14. An Ag concentration of the electrolytic ion water is high to some extent, and also, the water contained in the clothing allows the electrolytic ion water after the attachment to the clothing to wet and spread to a portion to which the mist is not attached, and thus, tumbling for about 10 minutes puts the entire clothing of 4 kg into a state where the electrolytic ion water is almost uniformly attached thereto.

The mist generated by the piezoelectric element is made of very small particles having an average particle diameter of 10 μm, which is in a white smoke-like state. A user can thus observe the mist processing step through the door of the washing and drying machine. Moreover, the mist intrudes between inner tub 14 and outer tub 12 to be attached to some extent, which is effective in disinfecting and antibacterial actions to inner tub 14 and outer tub 12, and utilizing the electrolytic mist generating device allows the washing tub to be continuously maintained in a state free of mold.

Moreover, as an improved additional value of the heat pump type washing machine, even in a case where dehumidification for a room where the washing machine is installed is performed, since the mist processing function maintains the disinfecting and mold-free state inside the washing machine, nasty smell is restrained from being caused even when the washing machine inside is utilized as a blower circuit.

Thereafter, as a drainage step, the electrolytic ion water remaining in recessed part 5 is discharged from drain pipe 61 through water supply and drain port 9 and switching valve 60 to end a series of operation.

Since the mist supply step to clothing 13 is performed after spin drying operation of the washing and drying machine, the water supply step and the electrolysis step are performed prior to the mist supply step.

Evaluations of the antibacterial effect were made for the clothing subjected to the mist processing. For the evaluations, a quantitative testing method based on JIS L1902 was referred to. The evaluations were made by sewing desized testing fabrics on clothing of 4 kg with thread in ten positions. As a result, in all the fabrics, a bacteriostatic activity value of 2 or more could be obtained.

### Embodiment 2

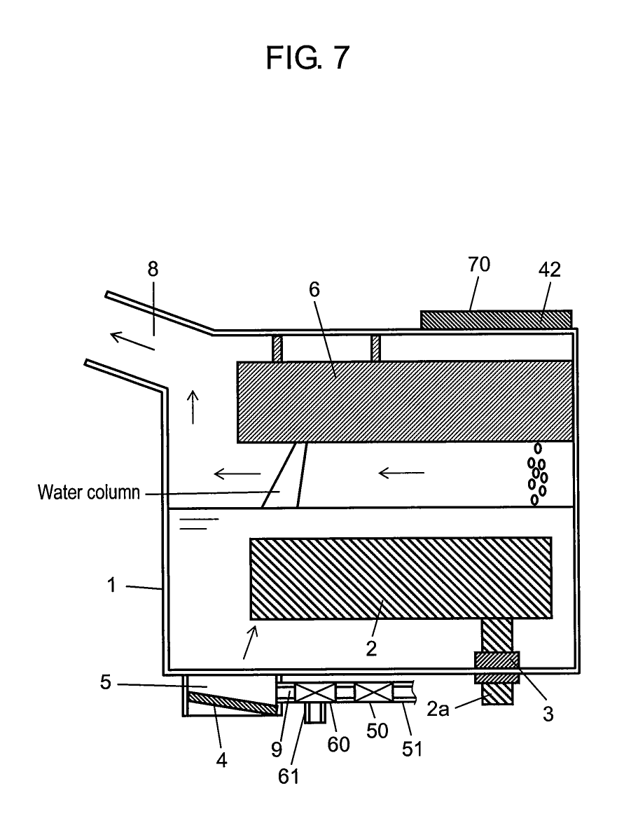

In Embodiment 2 of the present invention, an electrolytic mist generating device resembles that of Embodiment 1 of the present invention, and thus, a detailed description is omitted. FIG. 7 is a schematic configuration view of the electrolytic mist generating device of Embodiment 2 of the present invention. Here, in discharging device 70, a blowing fan is not provided, but intake port 42 is provided. A configuration is adapted such that the inside of electrolytic cell 1 is put into a negative pressure state to thereby take in air from intake port 42 and that the generated mist is discharged outside of electrolytic cell 1.

When a description is given to the washing machine shown in FIG. 4, by operating blower 19, a negative pressure force acts on the mist outlet 8 side of electrolytic mist generating device 40 so that the mist generated inside electrolytic cell 1 is directed to the inner tub 14 side.

### Embodiment 3

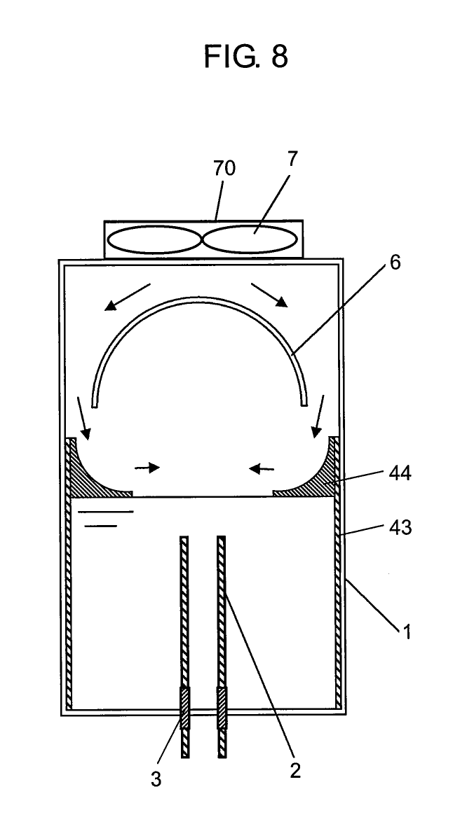

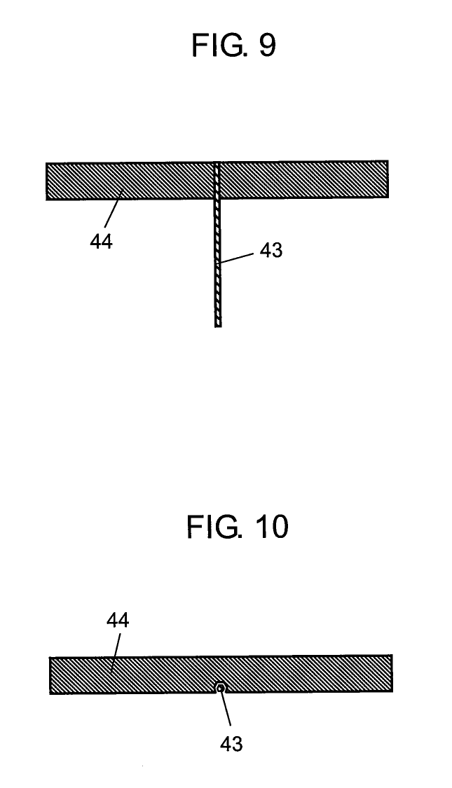

Also, in Embodiment 3 of the present invention, an electrolytic mist generating device resembles that of Embodiment 1 of the present invention, and thus, a detailed description is omitted. Different points from Embodiment 1 of the present invention are described. FIG. 8 is a schematic configuration view of the electrolytic mist generating device of Embodiment 3 of the present invention, and FIGS. 9 and 10 are a side view and a top view showing a relation between floats as wind guiding members and vertically guiding members of the same electrolytic mist generating device, respectively.

Vertically guiding members 43 of the floats are disposed on both side surfaces of electrolytic cell 1. A material thereof is made of a hexagonal POM rod. Floats 44 each having a fitting part for vertically guiding member 43 and serving as the blow guiding member are arranged. Each of floats 44 is made of a polyethylene blow-molded object, and has a substantially ¼ circular arc shape.

In the electrolytic mist supply step, floats 44 can move downward, following the water level on the water surface so as to play a role of directing the wind from rectifier 6 toward a side-surface lower direction to the water column extending in the oblique upper direction from the water surface. As a result, the mist can be generated smoothly.

While in the embodiments of the present invention, the piezoelectric element of 1.6 MHz is used, one that can be used in the present invention is not limited to this. 1.6 MHz is common in a piezoelectric element for use in a humidifier or the like, and produces a mist particle diameter of an average of about 4 μm. In addition to this, 2.4 MHz or 1 MHz is usable. However, with 2.4 MHz, a range of the water level enabling the mist to be generated is smaller as compared with 1.6 MHz. Moreover, with 1 MHz, a water level required for protecting the piezoelectric element from being destroyed due to idling becomes higher, and thus, the depth of the recessed part needs to larger.

While in the present embodiments of the present invention, the piezoelectric element is arranged by providing the recessed part having the depth of 15 mm from the bottom surface of the electrolytic mist generating cell, the arrangement that can be used in the present invention is not limited to this. A point to notice in the mist generation from the piezoelectric element is that an upper surface of the piezoelectric element should not be in a boil-dry state in operation. Accordingly, a certain lower surface water level enabling the usage is required, and as a result, the electrolytic water remains each time the electrolytic mist generating device is used. It is desirable to discard the remaining electrolytic water instead of leaving it as it is. Thus, providing the recessed part in the piezoelectric element part of the electrolytic mist generating cell can reduce a discarded volume of electrolytic water as much as possible. Moreover, by optimizing the depth of the recessed part in a range of 10 mm or more and 30 mm or less, the mist generation is enabled down to a border line between the bottom surface of the electrolytic mist generating cell and the recessed part.

While in the embodiments of the present invention, the piezoelectric element holds the inclination of 10 degrees with respect to the bottom surface of the electrolytic mist generating cell, the inclination that can be used in the present invention is not limited to this. It is considered to be desirable that the piezoelectric element has an inclination of at least 5 degrees or more inclination for effectively detaching the mist from the water column generated from the piezoelectric element. Moreover, although it is preferable that the inclination is larger to some extent for directing the circulating water in the electrode part direction adjacent to the piezoelectric element, too large an inclination reduces an effective water-level range enabling the mist generation, and thus, it is considered to be desirable that the inclination is set up to about 30 degrees.

While in the embodiments of the present invention, the substantially semi-cylindrical rectifier is used, one that can be used in the present invention is not limited to this. A semi-cylindrical shape or a semi-cylindrical shape having an R part are preferable for receiving the wind from the blowing fan to deliver on both sides of the rectifier and direct to the water column located behind.

While in the embodiments of the present invention, the semi-cylindrical rectifier made of glass is used, one that can be used in the present invention is not limited to this. Any material that does not so largely attenuate the energy that the water column possesses may be employed. A resin material is not preferable because it considerably absorbs and attenuates the energy that the water column possesses. Since the Ag ion is eluted, when a metal member is to be used, ionization tendency needs to be considered. A metal member covered with a passive film could be used. In addition to glass, ceramics, stainless steel and the like can be used.

While in the embodiments of the present invention, as the housing of the electrolytic cell, the material obtained by adding 2 wt % of titanic oxide to propylene resin is used to prevent light from intruding inside, one that can be used in the present invention is not limited to this. In addition to the configuration in which the housing itself is made of a light shielding material, a configuration in which a light shielding tape is stuck to the housing may also be employed. Alternatively, the configuration may be made such that the whole electrolytic mist generating device is contained in a light shielding member. With unstable metal ions such as an Ag ion, light shielding can dramatically delay the generation of silver oxide. The higher a concentration of an Age ion is, the larger this effect is.

While in the embodiments of the present invention, a polyethylene blow-molded object is used as each of the floats as the blow guiding member disposed on the side surface of the electrolytic mist generating cell, one that can be used in the present invention is not limited to this. Any molded object floating on water as the float serving as the blow guiding member disposed on the side surface of the electrolytic mist generating cell can be used. In addition to this, expanded polystyrene, expanded polyethylene or the like can be used.

While in the embodiments of the present invention, the rod-like POM is used as each of the vertically guiding members of the floats disposed on the side surfaces of the electrolytic mist generating cell, one that can be used in the present invention is not limited to this. In addition to the foregoing, any material having favorable slidability to the floats going up and down by being led by the guiding members, such as polypropylene and the like, may be employed.

While in the embodiments of the present invention, as the voltage that does not permit the piezoelectric element to generate the mist, ½ of the rated voltage for use in mist generation is employed, the voltage is not limited to this. Once the voltage exceeds ½, a volume of generated mist gradually becomes larger, which, in some cases, gives rise to a need for regulation to inhibit the generated mist from flowing outside. Less than 3/1 does not produce the water column from the water surface, resulting in a remarkable deterioration in a circulating state of the water. Accordingly, with the voltage that does not permit the mist to be generated, a range of ⅓ or more and ½ or less of the rated voltage is preferable.

While in the embodiments of the present invention, the electrolysis step is controlled by the constant current circuit, the step is not limited to this. In a case where the service water is soft water and characteristics thereof are constant to some extent, the constant current circuit can make effects by the Ag processing more uniform. However, in a case where the hardness of water is higher, electrolysis at a constant voltage can make the effects by the Ag processing more uniform.

While in the embodiments of the present invention, a description is given to the electrolytic mist generating device in which the operation is sequentially made up of the water supply step, the electrolysis step, the mist supply step, and the drainage step, the operation is not limited to this. The cleaning step may be added after the drainage step. Specifically, after the drainage step, the service water is supplied from water supply and drain port 9 up to a predetermined water level. Once the predetermined water level is sensed by the water level sensor, the switching valve is turned to a drainage direction to discharge the stored water at one time. This allows electrode part 2 surfaces used in the electrolysis, and an electrolytic cell 1 inner surface and a surface of piezoelectric element 4 to be cleaned in each use. Accordingly, even when a use interval of the electrolytic mist generating device becomes long, deposit accumulation can be restrained in long-term use because the inside of the electrolytic mist generating device has been cleaned. Even if the deposit accumulation occurs, the cleaning step allows the deposits to be discharged outside.

Moreover, a water supply step may be added after the cleaning step. In this case, after the series of electrolytic mist generating operation ends, electrolytic cell 1 is put into a state where water is stored to prepare for the next use. Accordingly, as a first step, the processing starts with a water replenishing step of replenishing shortage in volume of water with respect to the predetermined water level. This will allow the electrode part 2 surfaces used in the electrolysis, the electrolytic cell 1 inner surface or the surface of piezoelectric element 4 to be cleaned in each use. Finally, electrolytic cell 1 is put into the state where the water is stored to prepare for the next use. Thus, since the inside of the electrolytic mist generating device is not dry even if the use interval of the electrolytic mist generating device becomes long, the device can be maintained in a state where solid materials hardly occur even in a long-term use. Even if deposits occur, they can be discharged outside in the cleaning step.

While in the embodiments of the present invention, the electrolytic mist generating device is disposed in the front-surface-side upper portion of the oblique washing tub, the position is not limited to this. However, since disposing the electrolytic mist generating device in the front-surface-side upper portion allows the user to observe contact of the mist having an average particle diameter of 10 μm or less with washed clothing inside the washing tub, the user can visually check the clothing processing step with the mist.

While in the embodiments of the present invention, as the electrolysis step, the Ag ion water of 50 ppm is used, the concentration is not limited to this. Ag of 1 mg needs to be carried for clothing of 1 kg for stably obtaining the antibacterial effect in the clothing, and thus, Ag of 4 mg or more is needed for standard clothing of 4 kg. Moreover, a volume of mist that can be generated by the piezoelectric element is about 10 g/min or less. Although dilute Ag ion water is preferable for evenly carrying Ag on the clothing, processing time becomes longer. If the Ag ion water is concentrated excessively, it turns brownish from cloudy, which causes a concern of the harmful effect on the clothing. Accordingly, in light of the volume of the generated mist, the processing time and the harmful effect on the clothing, as a AG ion concentration, the usage at a level of 20 ppm or more and 200 ppm or less in 250 ml or less and 25 ml or more for the standard clothing of 4 kg is considered to be preferable.

While in the embodiments of the present invention, the mist supply step is performed while tumbling is performed after the final spin drying step, the step is not limited to this. However, after the electrolytic ion aqueous solution is attached to the washed clothing, the electrolytic ion aqueous solution further wets and spreads by utilizing contained water in the clothing, and even if unevenness in the mist attachment occurs, it could be corrected. Thus, high-concentration Ag ion water can be used.

### INDUSTRIAL APPLICABILITY

As described above, the electrolytic mist generating device of the present invention, which is a device capable of producing high-concentration metal ion water compactly with required minimum parts, can be applied to a wide range of applications such as an air washer, an air conditioner or water-related equipment requiring disinfections.

1. An electrolytic mist generating device comprising:
an electrolytic cell;
electrode parts where a pair of positive pole and negative pole are arranged in parallel and opposed to one another in the electrolytic cell;
a piezoelectric element that generates mist of electrolytic water generated inside the electrolytic cell;
a water supply device that supplies water into the electrolytic cell; and
a discharging device that discharges the mist from the electrolytic cell,
wherein production of the electrolytic water and mist generation are performed in the electrolytic cell.

2. The electrolytic mist generating device according to claim 1, wherein a rectifier is provided above the electrode parts, the piezoelectric element generates a water column toward the rectifier, and the discharging device supplies wind to the water column from sides thereof.

3. The electrolytic mist generating device according to claim 2, wherein the rectifier is provided in a concave shape with a side of the piezoelectric element opened to receive at least part of the water column.

4. The electrolytic mist generating device according to claim 1, wherein the water column generated by the piezoelectric element is formed by a water flow passing between the electrode parts.

5. The electrolytic mist generating device according to claim 1, wherein the electrolytic cell has a recessed part having a predetermined depth in a bottom portion thereof, and the piezoelectric element is arranged inside the recessed part so as to be inclined.

6. The electrolytic mist generating device according to claim 1, wherein the electrolytic cell is provided with a recessed part in a bottom portion thereof to dispose the piezoelectric element therein, and a water supply and drain port communicating with the electrolytic cell is provided in the recessed par.

7. The electrolytic mist generating device according to claim 1, wherein the electrolytic cell is configured so as to restrain light from entering an inside thereof.

8. The electrolytic mist generating device according to claim 2, wherein a material of the rectifier is any one of stainless steel, ceramics, and glass.

9. The electrolytic mist generating device according to claim 1, wherein the electrolytic cell has a float that guides wind to be supplied to the water column in accordance with a water level surface.

10. A washing machine comprising:
the electrolytic mist generating device according to claim 1;
a washing tub that contains laundry; an outer tub in which the washing tub is internally mounted rotatably; and
a water supply device that supplies washing water to the outer tub,
wherein mist generated by the electrolytic mist generating device is supplied to the washing tub.

11. The washing machine according to claim 10, wherein an inner surface of an introduction part from the electrolytic mist generating device to the washing tub is subjected to water repellent treatment.
